(19) United States
(12) Patent Application Publication
(10) Pub. No.: US 2012/0154137 A1
(43) Pub. Date: Jun. 21, 2012

(54) Traffic Warning Method

(76) Inventor: Shu-Nu LIN, Taichung City (TW)

(21) Appl. No.: 13/406,346

(22) Filed: Feb. 27, 2012

Related U.S. Application Data
(63) Continuation-in-part of application No. 12/541,911, filed on Aug. 14, 2009.

(51) Int. Cl. B60Q 1/34

(52) U.S. Cl. 340/475

(57) ABSTRACT

A traffic warning method comprises: a, preparing a light-emitting apparatus which is provided with plural warning lights arranged in rows, and the number of the warning lights in a middle row is greater than that of the respective rows at both sides thereof in such a manner that the number of the warning lights gradually decreases from the middle row toward those at both sides; b, designating the warning lights in a first row with sequential numbers and connecting the warning lights of the first row to the warning lights in other rows by broken line to form a plurality of groups of warning lights; c, turning on and off the warning lights one group by one group and the corresponding warning lights in the middle row can present a traffic sign—an arrow which gradually moves in a left or right direction.

This application is a continuation in part of U.S. patent application Ser. No. 12/541,911, and claims 1-3 are new.

### BACKGROUND OF THE INVENTION

1. Field of the Invention

The present invention relates to a traffic warning method; and more particularly to a traffic warning method which can be applied to show a traffic sign which is gradually moving in a desired direction, which enhances the visual effect to call the attention of the vehicles behind.

2. Description of the Prior Art

With the development of the transportation, traffic warning device becomes more and more important to traffic safety.

The existing traffic warning devices for transportations are mostly installed at both sides of the rear end of the transportations to provide warning signals through continuous flashing of a left bulb and a right bulb. The flashing of the left bulb represents a left-turn signal, and the flashing of the right bulb represents a right-turn signal. However, the left and right bulbs are disposed adjacent to the rear light of the transportation, so that the left-turn and right-turn signals generated by the left and right bulbs are just not as clear as clear as they should be due to the interference of the rear light.

In addition, there are still a lot of transportations not provided with any warning device, such as bicycle. Therefore, as safety awareness increases among consumers, some helmet producers start to put warning devices on the safety helmets. The safety helmets with warning function are divided into two types: one is provided with a warning light which can emit light continuously without intermittently flashing, and the other is provided with three warning lights which are electrically connected with the left-turn light, the right-turn light and the braking light, respectively.

As known from the above description, although the existing transportations or safety helmets all have the warning function, they still suffer from the following defects:

1. Poor warning effect: the continuously-illuminating warning lights are unable to produce left-turn, right-turn and braking warning signals, therefore, it is prone to causing traffic accidents.

2. Complicated structure: the left-turn, right-turn and the braking lights are normally disposed at the left, right and rear sides of the safety helmet, so that it totally requires at least three lights on the safety helmet, which makes the structure of the safety helmet relatively complicated. Furthermore, if the installation of the warning lights requires drilling holes in the safety helmet, the structure strength of the safety helmet will be reduced.

3. The left-turn, right-turn and the braking warning lights don't send out any special warning signals, so they cannot provide better warning effect: when a motorbike with the warning lights turns left or right or it brake is actuated, a corresponding one of the left-turn, right-turn or braking warning lights of the safety helmet will flash, but the other two warning lights won't. In this case, the vehicles behind can only see one warning light illuminating but without knowing which one of the warning lights is illuminating. Although the three warning lights can be set with different colors, there is no provision for color of the warning lights, so it is difficult to achieve a fine warning effect.

The present invention has arisen to mitigate and/or obviate the afore-described disadvantages.

### SUMMARY OF THE INVENTION

The primary objective of the present invention is to provide a traffic warning method which can enhance the warning effect and improve the traffic safety.

In order to achieve the above objective, a traffic warning method comprises the following steps:

a, arranging a light-emitting apparatus on an object, the light-emitting apparatus being provided with a battery and plural warning lights, the plural warning lights being arranged in an odd number of rows, and the number of the warning lights in a middle row of the whole warning lights is greater than that of the respective rows at both sides thereof in such a manner that the number of the warning lights gradually decreases from the middle row toward those at both sides, and the rows at both sides of the middle row are symmetrical about the middle row;

b, designating the warning lights in a first row with sequential numbers and connecting the warning lights of the first row to the warning lights in other rows by broken line to form a plurality of groups of warning lights;

c, turning on a first group of warning lights and the warning lights in the middle row at the right side of the first group of warning lights, thus presenting a left arrow <;

d, then, turning off all the first group of warning lights, except the warning light at the tip of the arrow, while turning on a second group of warning lights;

e, then, turning off all the second group of warning lights, except the warning light located at the tip of the arrow, while turning on a third group of warning lights;

f, in this way, the plurality of groups of warning lights are turned on and off one by one, and then the cycle of turning on and off the warning lights repeats, a left arrow ← gradually moving in a left direction is presented; or, by reversely performing the steps of c, d and e, a right arrow → gradually moving in a right direction is presented.

### BRIEF DESCRIPTION OF THE DRAWINGS

FIG. 1 is a perspective view of a light-emitting apparatus used in combination with a traffic warning method in accordance with the present invention;

FIG. 2 is a plane view of the light-emitting apparatus for the traffic warning device of FIG. 1;

FIG. 3 is a plane view of another light-emitting apparatus used in combination with the traffic warning method in accordance with the present invention;

FIG. 4 is a plane view showing that the light-emitting apparatus used in combination with the traffic warning method of FIG. 2 presents a left-turn sign;

FIG. 5 is a plane view showing that the light-emitting apparatus used in combination with the traffic warning method of FIG. 2 presents a right-turn sign;

FIG. 6 is a schematic view showing that the light-emitting apparatus in accordance with the present invention is disposed on a safety helmet;

FIG. 7 is a perspective view of a remote control in accordance with the present invention;

FIG. 8 is a schematic view showing that the light-emitting apparatus in accordance with the present invention is disposed on a safety helmet which is provided with a solar panel;

FIG. 9 is a perspective view showing that the light-emitting apparatus of the present invention is disposed on a bicycle, and the remote control is disposed on the handlebar of the bicycle;

FIG. 10 is a schematic view showing that the light-emitting apparatus of the present invention is disposed at the rear side of a saddle of the bicycle;

FIG. 11 is a schematic view showing that the light-emitting apparatus of the present invention is disposed at the rear side of a seat of an electric bicycle;

FIG. 12 is a schematic view showing that the light-emitting apparatus of the present invention is disposed at an upper side of a rear seat of an auto car; and

FIG. 13 is a flow chart showing the traffic method in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

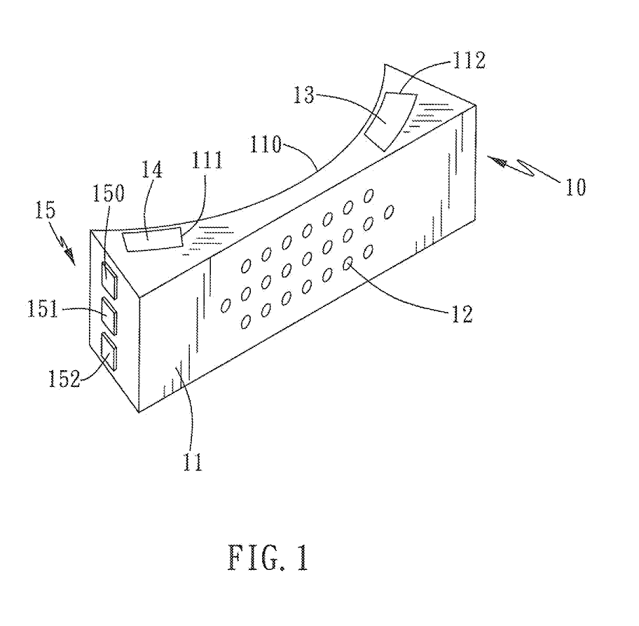

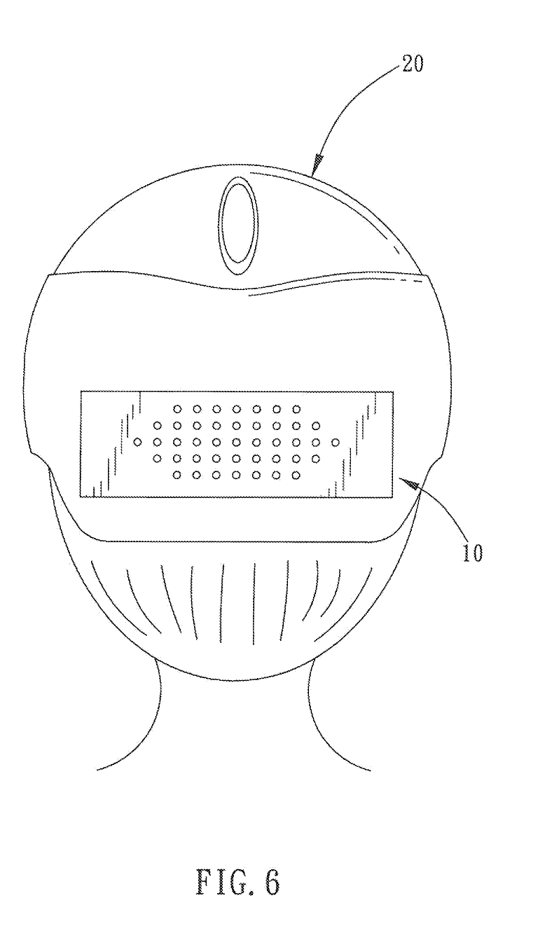

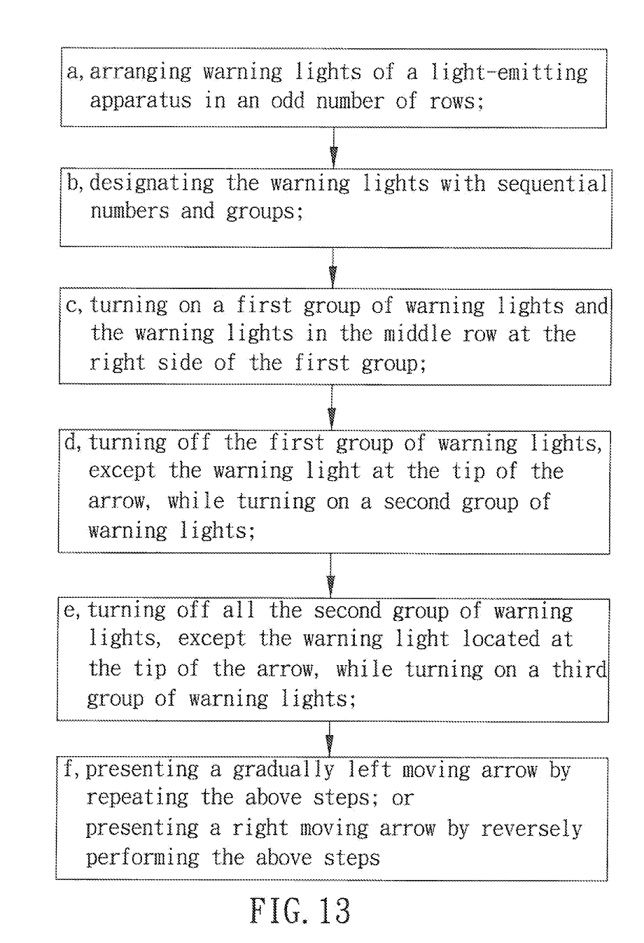

Referring to FIGS. 1-6 and 13, a traffic warning method in accordance with the present invention is to arrange a light-emitting apparatus 10 on a safety helmet 20. The light-emitting apparatus 10 is allowed to receive a wireless signal from a remote control 30 to present a left-turn, a right-turn or a continually-flashing sign to call the attention of the vehicles behind.

The light-emitting apparatus 10 includes a housing 11. The housing 11 includes a curved mating surface 110 at a rear end thereof to adhere the light-emitting apparatus 10 to the rear side of the safety helmet 20 or a desired position. The front end of the housing 11 is provided with plural regularly-arranged warning lights 12. The housing 11 is defined with a receiving groove 111 for holding a signal receiver 13 at a right side of the upper end surface thereof, and a receiving groove 112 for holding a battery 14 at a left side of the upper end surface thereof. The housing 11 is further provided on a left end surface thereof with a control key set 15 which includes, in order from top to bottom, an ON key 150, an OFF key 151 and an AUTO key 152.

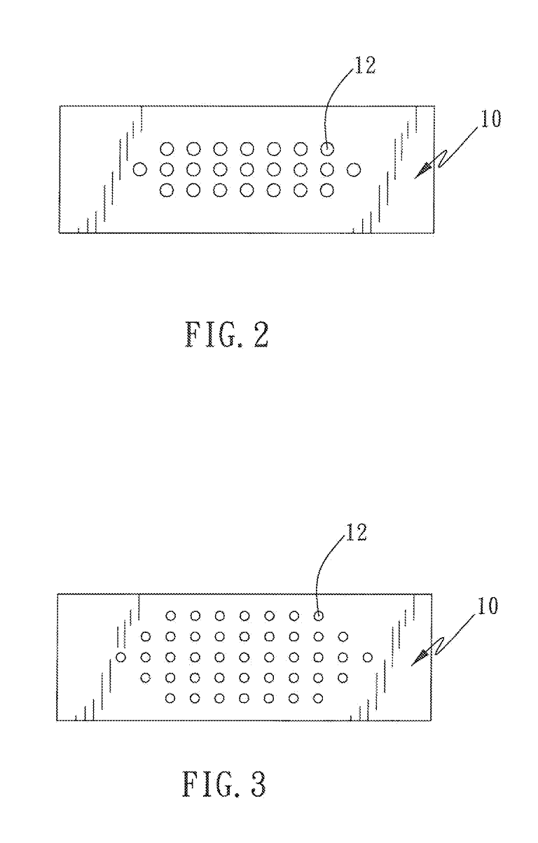

The warning lights 12 are arranged in an odd number of rows, and the number of the warning lights 12 in the middle row of the whole warning lights 12 is greater than that of the respective rows at both sides thereof in such a manner that the number of the warning lights 12 gradually decreases from the middle row toward those at both sides. The rows of warning lights 12 at both sides of the middle row are symmetrical to each other about the middle row. Referring to FIG. 2, the warning lights 12 are arranged in three rows that are a first row, a second row and a third row, and the first row and the third row are symmetrical to each other about the second row. The second row has two more warning lights at both ends thereof than the first and third rows. Referring to FIG. 3, the warning lights 12 can also be arranged in five rows that are a first row, a second row, a third row, a fourth row, and a fifth row, the first and the second rows and the fourth and the fifth rows are symmetrical to one another about the third row. The third row has two more warning lights at both ends thereof than the second row and the fourth row and has four more warning lights at both ends thereof than the first row and the fifth row. By following this rule, the warning lights 12 can be arranged in other forms.

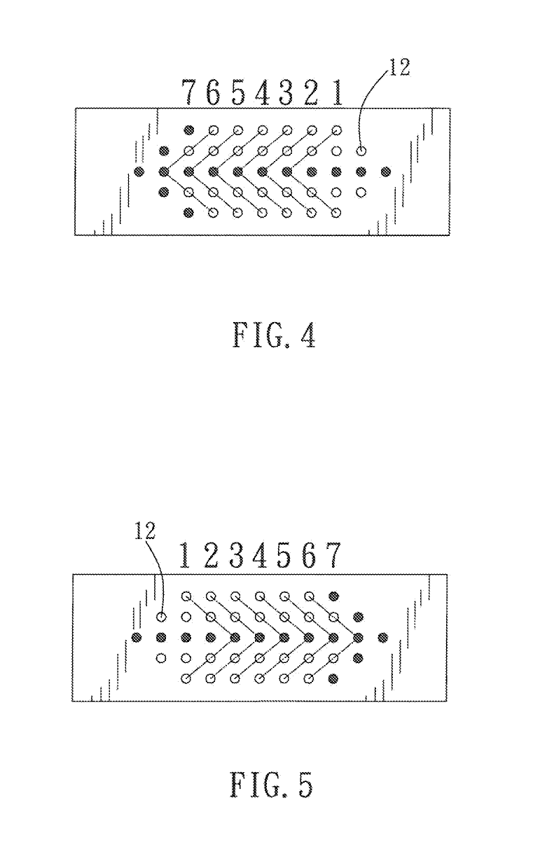

Referring to FIGS. 4 and 5, a left-turn, or right-turn warning sign produced by the warning lights 12 is a left arrow ← gradually moving in the left direction or right arrow → gradually moving in the right direction. As shown in FIG. 4, the warning lights 12 in the first row are designated from 1 to 7 in order and connected to the warning lights in other rows by broken line to form seven groups of warning lights. By such arrangements, the method for the warning lights 12 to present a left-turn sign is described as follows:

Simultaneously turning on the first group of warning lights 12 and the warning lights 12 in the third row at the right side of the first group of warning lights 12, thus presenting a left arrow <; then, turning off all the first group of warning lights 12, except the one at the tip of the arrow, while turning on the second group of warning lights 12; then, turning off all the second group of warning lights 12, except the one located at the tip of the arrow, while turning on the third group of warning lights 12, by following this rule, the seven groups of warning lights 12 will be turned on in order. By such arrangements, the warning lights 12 will be turned on to present a left arrow ← gradually moving in the left direction, which not only enhance the visual effect to call the attention of the vehicles behind but have clear indication meaning.

Likewise, when the transportations need to turn right, as shown in FIG. 5, seven groups of warning lights will be turned on in order from left to right to present a right arrow gradually moving in the right direction.

In addition, the warning lights 12 in the middle portion of all the warning lights 12 can be made to continuously emit light so as to present various signs such as a rectangular, a cross-shaped, and a rhombic signs.

In general, a traffic warning method comprises the following steps:

a, arranging a light-emitting apparatus on an object, the light-emitting apparatus being provided with a battery and plural warning lights, the plural warning lights being arranged in an odd number of rows, and the number of the warning lights in a middle row of the whole warning lights is greater than that of the respective rows at both sides thereof in such a manner that the number of the warning lights gradually decreases from the middle row toward those at both sides, and the rows at both sides of the middle row are symmetrical about the middle row;

b, designating the warning lights in a first row with sequential numbers and connecting the warning lights of the first row to the warning lights in other rows by broken line to form a plurality of groups of warning lights;

c, turning on a first group of warning lights and the warning lights in the middle row at the right side of the first group of warning lights, thus presenting a left arrow <;

d, then, turning off all the first group of warning lights, except the warning light at the tip of the arrow, while turning on a second group of warning lights;

e, then, turning off all the second group of warning lights, except the warning light located at the tip of the arrow, while turning on a third group of warning lights;

f, in this way, the plurality of groups of warning lights are turned on and off one by one, and then the cycle of turning on and off the warning lights repeats, a left arrow ← gradually moving in a left direction is presented; or by reversely performing the steps of c, d and e, a right arrow → gradually moving in a right direction is presented.

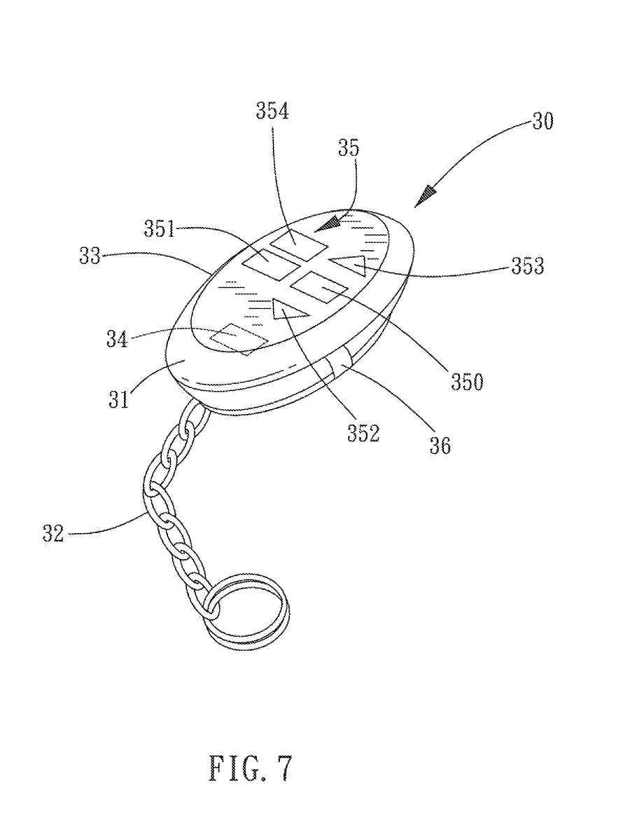

As shown in FIG. 7, the remote control 30 includes an elliptic housing 31 to be adhered to the transportation provided with the light-emitting apparatus 10 or any other desired positions. The housing 31 is connected to a hanging chain 32 in such a manner that the remote control 30 can be hung on a desired position by the hanging chain 32. The housing 31 has a rear end provided with an emitter 33. The upper end surface of the housing 31 is provided with a battery 34 at a left side thereof and a control key set 35 in the middle portion adjacent to the right side thereof.

The control key set 35 includes an ON key 350 adjacent to the front end thereof, an OFF key 351 adjacent to the rear end thereof, a left-turn key 352 at the left side of the ON key 350, and a right-turn key 353 at the right side of the ON key 350. By pressing the respective keys of the control key set 35, the emitter 33 can emit a corresponding wireless signal, and then the receiver 13 of the light-emitting apparatus 10 will receive the wireless signal and control the warning lights 12 to work correspondingly. If the ON key 350 is pressed, the warning lights 12 will be turned on to continuously emit light, and if the OFF key 351 is pressed, the warning lights 12 will be turned off. If the left-turn key 352 is pressed, the warning lights 12 will be turned on to present the left-turn sign. If the right-turn key 353 is pressed, the warning lights 12 will be turned on to present the right-turn sign.

In addition, the front end of the housing 31 of the remote control 30 can be defined with a socket 36 in such a manner that the remote control 30 can be electrically connected to the left-turn and right-turn lights of the motorbike through the socket 36. Further, at the right side of the OFF key 351 is disposed an AUTO key 354. If the AUTO key 354 is pressed, the emitter 33 can directly emit a signal corresponding to the signal sent out by the left-turn or the right-turn light of the motorbike to control the warning lights 12 to emit light synchronously. By such arrangements, when the traffic warning device of the present invention is applied to the bicycle, the respective keys of the control key set 35 can be pressed to make the warning lights 12 present a corresponding sign, and when the traffic warning device of the present invention is applied to the motorbike, the AUTO key 354 can be pressed to make the warning lights 12 work synchronously with the left-turn and right-turn lights of the motorbike to achieve the double warning effect.

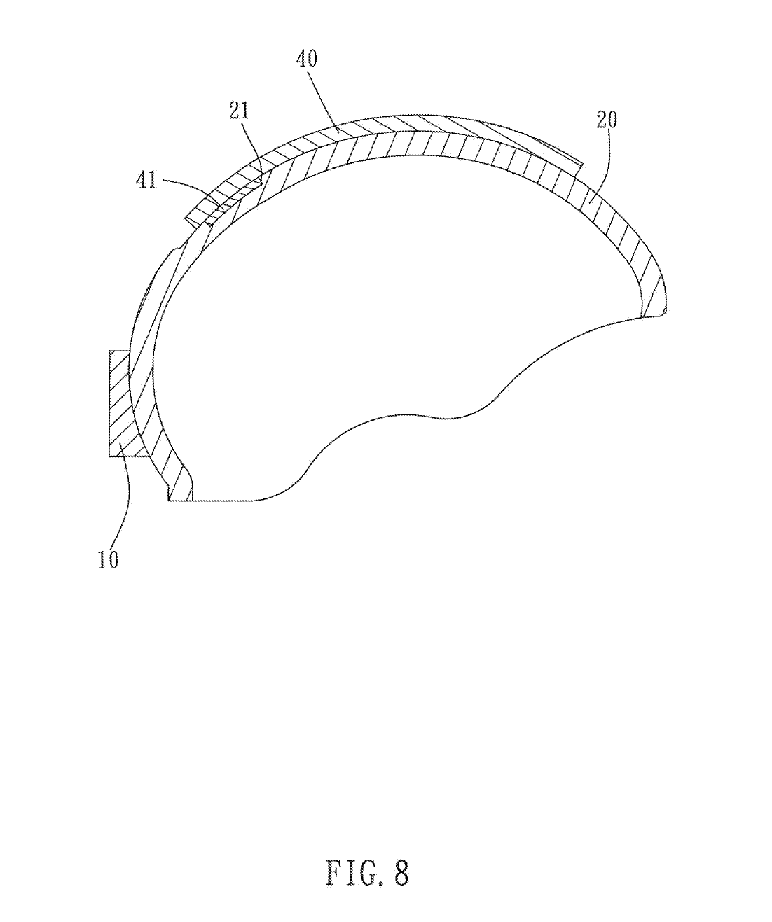

Further referring to FIG. 8, the safety helmet 20 can be provided with a solar panel 40 on an upper surface thereof and defined with a receiving groove 21 for accommodation of a storage battery 41 which can store the electric energy generated from the solar panel 40 and supply the stored electric energy to the light-emitting apparatus 10. In addition, the battery 14 of the light-emitting apparatus 10 can be connected to the storage battery 41, so that the battery 14 can also be charged by the solar panel 40.

The light-emitting apparatus 10 is adhered to the safety helmet 20 and can also be applied to other special positions. In addition, since the light-emitting apparatus 10 itself is provided with the battery 14 and the control key set 15, the ON key 150, the OFF key 151 and the AUTO key 152 can be pressed to make the waning lights 12 emit light continuously, be turned off and present different signs, respectively. Therefore, the light-emitting apparatus 10 can work independently from the remote control 30.

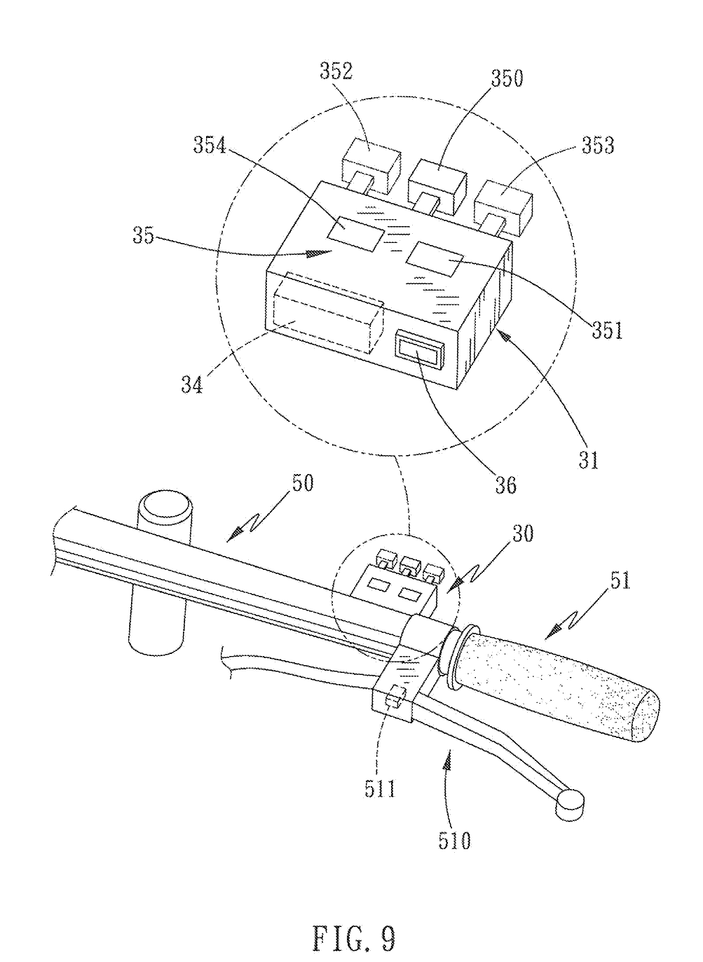

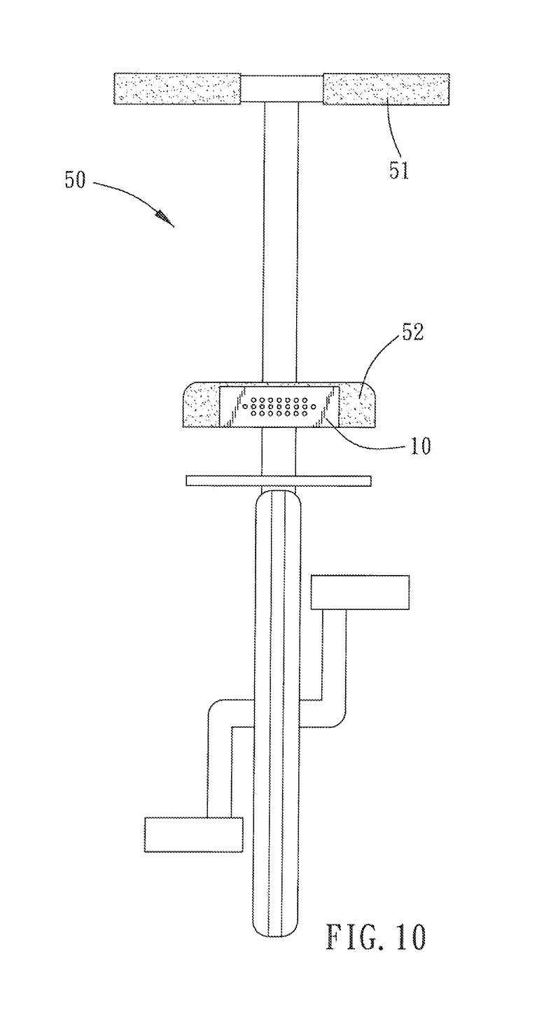

Referring to FIG. 9, the remote control 30 can be directly fixed on the handlebar 51 of the bicycle 50 and cooperate with the brake device 510 on the handlebar 51. The brake device 510 is further provided with a micro switch 511, and the micro switch 511 is electrically connected to the remote control 30, so that the brake device 510 can be used to control the remote control 30 by triggering the micro switch 511. When the brake device 510 is pressed, the micro switch 511 will control the remote control 30 to turn on the light-emitting apparatus 10, presenting a braking sign. In order to be pressed conveniently, the respective keys of the remote control 30 which control the light, such as the ON key 350, the left-turn key 352, and the right-turn key 353, can be in the form of a micro switch. Other keys of the remote control 30 including the OFF key 351 and AUTO key 354 each are sill in the form of a touch switch. Referring to FIG. 10, the light-emitting apparatus 10 can also be disposed at the rear side of the saddle 52 of the bicycle, and the remote control 30 disposed on the handlebar 51 can also control the traffic signs of the light-emitting apparatus 10.

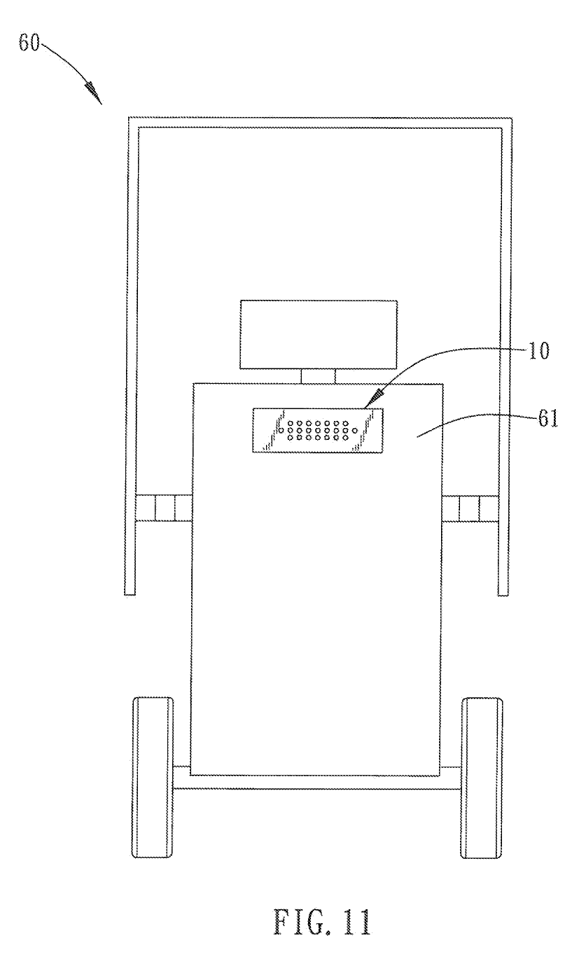

Referring to FIG. 11, besides being disposed on the safety helmet 20 and the bicycle 50, the traffic warning device of the present invention can also be disposed on an electric bicycle 60. A common electric bicycle is only provided with a left-turn light and a right-turn light both sides of the rear wheel or even not provided with any warning lights, the left-turn and the right-turn lights are very small, and the height of the electric bicycle is relatively small, so the warning lights of the electric bicycle are difficult to exert the effective warning effect. Therefore, the light-emitting apparatus 10 is disposed at a rear side of a seat 61 of the electric bicycle 60, so that the light-emitting apparatus 10 can be easily observed by the vehicles behind, improving the traffic safety of the electric bicycle 60.

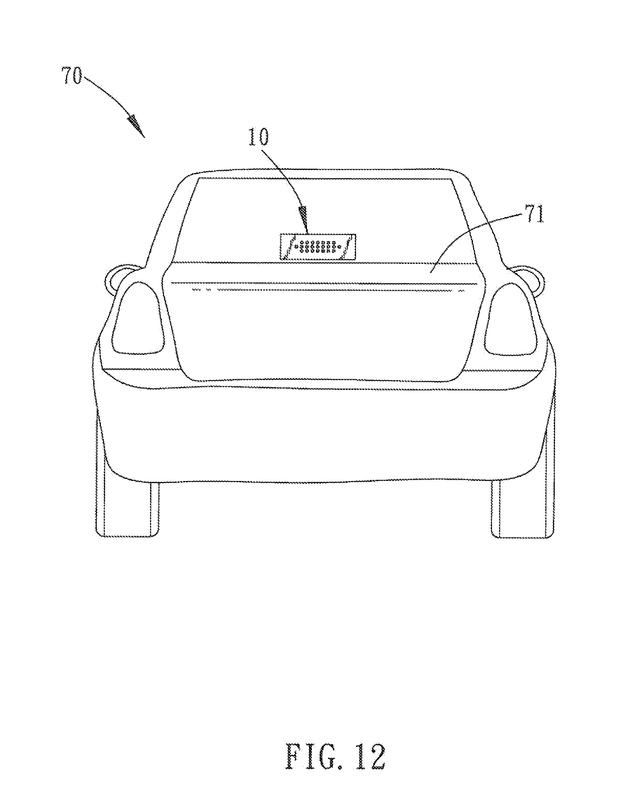

Additionally, as shown in FIG. 12, the light-emitting apparatus 10 of the traffic warning device of the present invention can also be disposed at an upper side of the rear seat 71 of an auto car, and the remote control 30 is then connected to the left-turn and the right-turn lights of the auto car 70 in such a manner that the light-emitting apparatus 10 can work synchronously with the left-turn and right-turn lights of the auto car 70. Due to the light-emitting apparatus 10, the vehicles behind can clearly distinguish the moving trend of the auto car 70, improving the traffic safety.

While we have shown and described various embodiments in accordance with the present invention, it is clear to those skilled in the art that further embodiments may be made without departing from the scope of the present invention.

What is claimed is:

1. A traffic warning method comprising the following steps:
a, arranging a light-emitting apparatus on an object, the light-emitting apparatus being provided with a battery and plural warning lights, the plural warning lights being arranged in an odd number of rows, and the number of the warning lights in a middle row of the whole warning lights is greater than that of the respective rows at both sides thereof in such a manner that the number of the warning lights gradually decreases from the middle row toward those at both sides, and the rows at both sides of the middle row are symmetrical about the middle row;
b, designating the warning lights in a first row with sequential numbers and connecting the warning lights of the first row to the warning lights in other rows by broken line to form a plurality of groups of warning lights;
c, turning on a first group of warning lights and the warning lights in the middle row at the right side of the first group of warning lights, thus presenting a left arrow <;
d, then, turning off all the first group of warning lights, except the warning light at the tip of the arrow, while turning on a second group of warning lights;
e, then, turning off all the second group of warning lights, except the warning light located at the tip of the arrow, while turning on a third group of warning lights;
f, in this way, the plurality of groups of warning lights are turned on and off one by one, and then the cycle of turning on and off the warning lights repeats, a left arrow ← gradually moving in a left direction is presented; or, by reversely performing the above steps of c, d and e, a right arrow → gradually moving in a right direction is presented.

2. The traffic warning method as claimed in claim 1, wherein the light-emitting apparatus is put on a helmet.

3. The traffic warning method as claimed in claim 1, wherein the light-emitting apparatus is put on a vehicle.
